(19) United States
(12) Patent Application Publication
(10) Pub. No.: US 2026/0349994 A1
(43) Pub. Date: Nov. 5, 2026

(54) LEARNING APPARATUS, LEARNING METHOD, AND COMPUTER READABLE MEDIUM

(71) Applicant: Mitsubishi Electric Corporation, Tokyo (JP)

(72) Inventor: Kentaro KAZAMA, Tokyo (JP)

(73) Assignee: Mitsubishi Electric Corporation, Tokyo (JP)

(21) Appl. No.: 19/715,382

(22) Filed: Jun. 22, 2026

Related U.S. Application Data
(63) Continuation of application No. PCT/JP2024/005618, filed on Feb. 16, 2024.

(51) Int. Cl. G06F 16/242; G06F 16/22

(52) U.S. Cl. CPC G06F 16/242; G06F 16/2237

(57) ABSTRACT

A learning apparatus (100) includes an embedded learning unit (132) that when each element of a triple (D1) that consists of two entities and one relation that are included in a target knowledge graph, a knowledge graph, is regarded as a target element, generates an embedded vector that corresponds to the target element based on a target vector representation that corresponds to the target element and on text information that corresponds to the target element, and learns a knowledge graph embedded representation that corresponds to the target knowledge graph based on the embedded vector (D6) that is generated.

### CROSS REFERENCE TO RELATED APPLICATION

This application is a Continuation of PCT International Application No. PCT/JP 2024/005618, filed on Feb. 16, 2024, which is hereby expressly incorporated by reference into the present application.

### TECHNICAL FIELD

The present disclosure relates to a learning apparatus, a learning method, and a learning program.

### BACKGROUND ART

A knowledge graph is a means of describing real-world knowledge in a form that is easily readable by a computer. Knowledge represented by the knowledge graph is possible to be applied to various uses, such as a search system, a dialogue system, and the like. As a specific example, a knowledge graph is used in a recommendation system for a product for a customer.

### CITATION LIST

### Patent Literature

Patent Literature 1: JP 6954049 B2

### SUMMARY OF INVENTION

### Technical Problem

Patent Literature 1 discloses technology to, when embedding an entity relationship in a vector space, search an external database to identify a relationship that is inversely equivalent to each other, and increase the number of combinations of entity relationships based on the relationship that is identified. This technology, however, has an issue in that in a case where auxiliary information such as text and the like accompanies the entity relationship, the auxiliary information such as the text and the like cannot be used for learning an embedded representation.

The present disclosure aims to improve expressiveness of knowledge graph embedding by making use of text information that corresponds to an entity relationship.

### Solution to Problem

A learning apparatus according to the present disclosure includes: an embedded learning unit, when each element of a triple that consists of two entities and one relation that are included in a target knowledge graph, a knowledge graph, is regarded as a target element, to generate an embedded vector that corresponds to the target element based on a target vector representation that corresponds to the target element and on text information that corresponds to the target element, and to learn a knowledge graph embedded representation that corresponds to the target knowledge graph based on the embedded vector that is generated.

### Advantageous Effects of Invention

According to the present disclosure, when each element of a triple is regarded as a target element, an embedded learning unit generates an embedded vector that corresponds to the target element based on a target vector representation that corresponds to the target element and text information that corresponds to the target element, and learns a knowledge graph embedding representation based on the embedded vector that is generated. Here, the triple consists of two entities and one relation that are included in a target knowledge graph.

Therefore, according to the present disclosure, by utilizing text information that corresponds to an entity relationship, expressiveness of knowledge graph embedding can be improved.

### BRIEF DESCRIPTION OF DRAWINGS

FIG. 1 is a diagram illustrating an example of a configuration of an information processing system 90 according to Embodiment 1.

FIG. 2 is a diagram illustrating an example of a configuration of a learning apparatus 100 according to Embodiment 1.

FIG. 3 is a diagram illustrating specific examples of triples D1 according to Embodiment 1.

FIG. 4 is a diagram illustrating specific examples of triples D1 according to Embodiment 1.

FIG. 5 is a diagram illustrating an example of a hardware configuration of the learning apparatus 100 according to Embodiment 1.

FIG. 6 is a flowchart illustrating operation of the learning apparatus 100 according to Embodiment 1.

FIG. 7 is a diagram illustrating an example of a hardware configuration of a learning apparatus 100 according to a variation of Embodiment 1.

FIG. 8 is a diagram illustrating an example of a configuration of an information processing system 91 according to Embodiment 2.

FIG. 9 is a diagram illustrating an example of a configuration of a learning apparatus 101 according to Embodiment 2.

FIG. 10 is a flowchart illustrating operation of the learning apparatus 101 according to Embodiment 2.

FIG. 11 is a diagram illustrating an example of a configuration of an information processing system 92 according to Embodiment 3.

FIG. 12 is a diagram illustrating an example of a configuration of a learning apparatus 102 according to Embodiment 3.

FIG. 13 is a diagram describing a process of an obtaining unit 160 according to Embodiment 3, with (a) being a diagram describing a process of generating a query D9, and (b) being a diagram describing a process of generating a prompt D10.

FIG. 14 is a flowchart illustrating operation of the learning apparatus 102 according to Embodiment 3.

### DESCRIPTION OF EMBODIMENTS

In a description of the embodiments and in drawings, same reference signs are added to same elements and corresponding elements. A description of elements having the same reference signs added will be suitably omitted or simplified. Arrows in diagrams mainly indicate flows of data or flows of processes. “Unit” may be suitably replaced with “circuit”, “step”, “procedure”, “process”, or “circuitry”.

### Embodiment 1

The present embodiment will be described in detail below while referring to the drawings.

### Description of Configuration

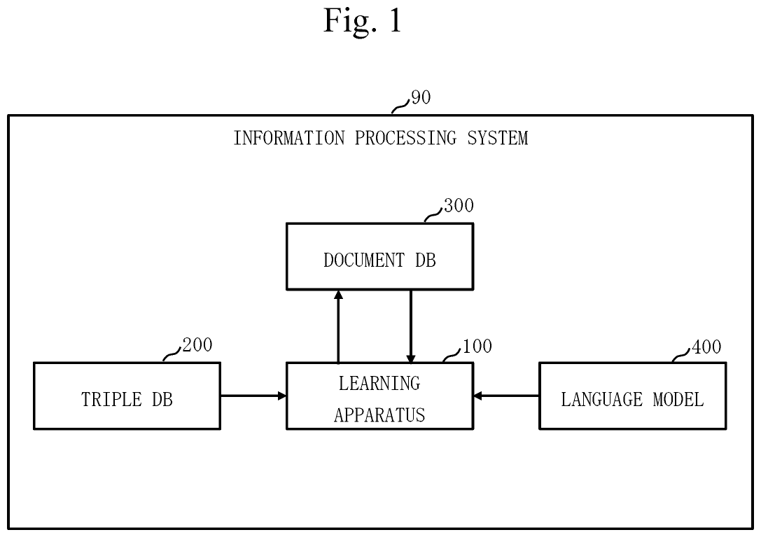

FIG. 1 illustrates an example of a configuration of an information processing system 90 according to Embodiment 1. The information processing system 90 includes a learning apparatus 100, a triple DB 200, a document DB 300, and a language model 400. DB is an abbreviation for database.

The information processing system 90 has a function to learn a knowledge graph embedding representation. As a specific example, the information processing system 90 may be used for knowledge graph completion tasks such as link prediction and the like that find an author of a paper from text of the paper.

As will be described later, the information processing system 90 learns the knowledge graph embedding representation using a triple that consists of entities and a relation within a knowledge graph. In a case where text that corresponds to an element in the triple exists, the text is used at a time of learning the knowledge graph embedding representation. The knowledge graph that is learned by the information processing system 90 may be used, as specific examples, in a recommendation system for a product, a service, or the like, a search system, a dialogue system, a question-answering system, a decision support system, or the like.

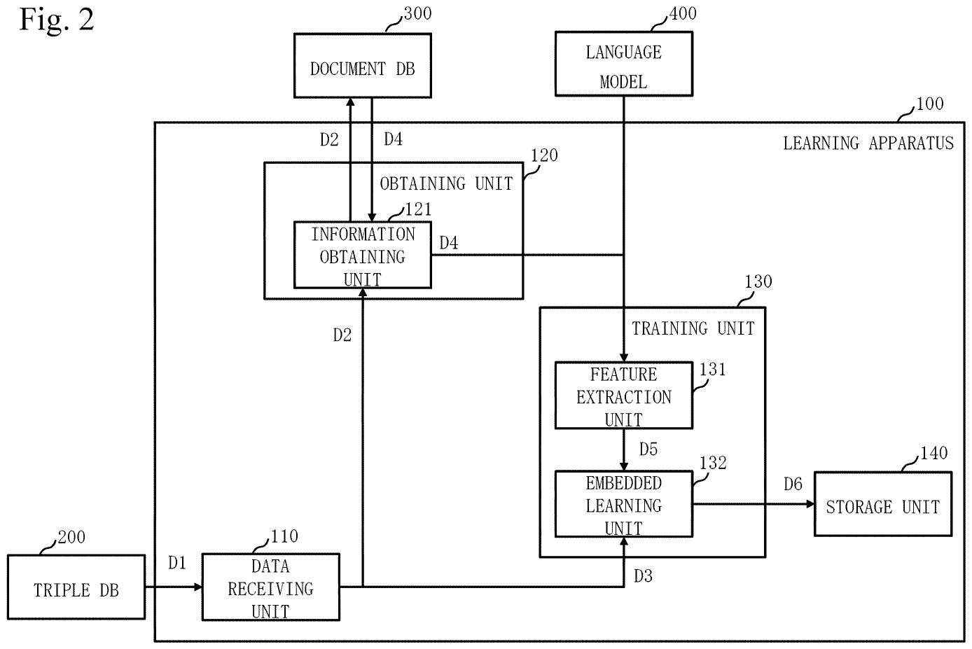

FIG. 2 illustrates an example of a configuration of the learning apparatus 100 according to Embodiment 1.

The learning apparatus 100 includes a data receiving unit 110, an obtaining unit 120, a training unit 130, and a storage unit 140.

The data receiving unit 110 has a function to receive a triple D1 from the triple DB 200, obtain any element that is included in the triple D1 that is received as an element D2, and obtain a vector representation D3 of the element D2 that is obtained. The triple D1 is data that indicates a combination of a head h and a tail t that correspond to two entities that are included in the knowledge graph, and one relation r that corresponds to the two entities. That is, the triple D1 consists of two entities and a relation that are included in a target knowledge graph that is the knowledge graph. The triple D1 is usually represented in a format, <h, r, t>.

The element D2 is an element that is selected from the elements included in the triple D1. That is, the element D2 indicates one of h, r, and t.

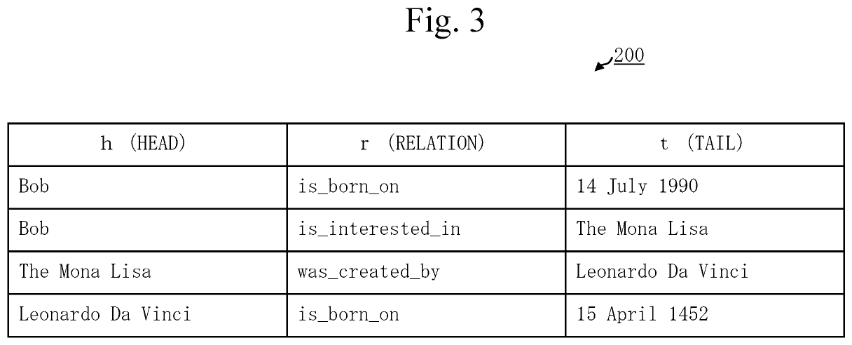

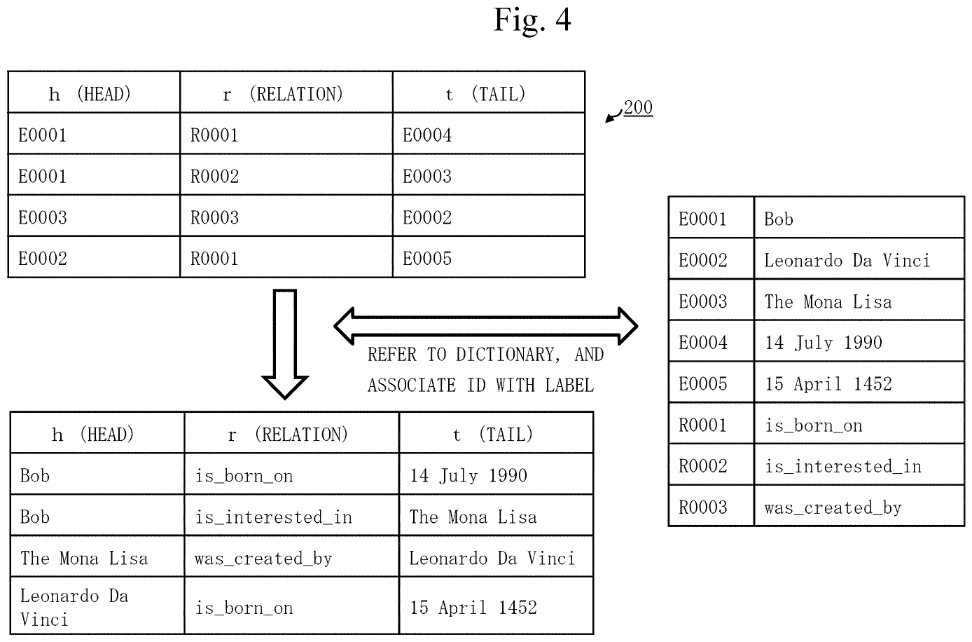

Specific examples of the triple D1 and the element D2 will be described using FIG. 3 and FIG. 4.

FIG. 3 illustrates an example of each triple D1 that the data receiving unit 110 receives.

As mentioned above, each triple D1 consists of a head h, a tail t, and a relation r. In the triple D1, a label string that represents each of the elements, the head h, the tail t, and the relation r, is stored. As a specific example, a triple, <Bob, is_born_on, 14 July 1990> represents a fact that “Bob was born on July 14, 1990.”

The data receiving unit 110 selects any element from the triple D1 and stores the element that is selected in the element D2. That is, relating to the above-mentioned specific example, a value that is to be stored in the element D2 is one of “Bob”, “is_born_on”, and “14 July 1990”.

FIG. 4 illustrates different specific examples of triples D1 that the data receiving unit 110 receives.

A value stored in each of the head h, the tail t, and the relation r that are included in the triple D1 is not necessarily a label string that represents each element. As a specific example, there is also a case where each element is converted into a format such as an ID, such as E0001 and the like, that is easy to handle within a computer. In such a case, a correspondence table of IDs and labels is inputted to the data receiving unit 110, along with each ID that indicates a triple as the triple D1. At this time, the data receiving unit 110 executes a process that restores each element of the triple to a label string by associating each ID with a label using the correspondence table that is inputted.

The vector representation D3 that the data receiving unit 110 obtains is a structural vector representation and is a vector representation that corresponds to the element D2. The vector representation D3 is represented as any dimensional real-valued vector that represents the element D2.

The data receiving unit 110 inquires the storage unit 140 whether or not the vector representation that corresponds to the element D2 exists. In a case where the vector representation that corresponds to the element D2 exists, the data receiving unit 110 regards the vector representation that exists as the vector representation D3. On the other hand, in a case where the vector representation that corresponds to the element D2 does not exist, the data receiving unit 110 generates a real-valued vector by any initialization method, and regards the real-valued vector that is generated as the vector representation D3. Here, the data receiving unit 110 may generate the real-valued vector by random numbers according to a uniform distribution, or may use a normal distribution instead of the uniform distribution. The initialization method, however, is not an essential feature of the present disclosure.

The data receiving unit 110 outputs the element D2 to the obtaining unit 120, and outputs the vector representation D3 to the training unit 130.

The obtaining unit 120 has a function to obtain from the document DB 300, text D4 that corresponds to the element D2 that is inputted from the data receiving unit 110. The obtaining unit 120 may have a function to determine whether or not text information that corresponds to the element D2 exists in the document DB 300. The document DB 300 is a database that consists of document data.

The text D4 that corresponds to the element D2 is the text information that corresponds to the element D2, and as a specific example, is text that describes the element D2, or is text that is supplemental information on the element D2. As a specific example, in a case where the element D2 is “The Mona Lisa” that is indicated in FIG. 3, the text D4 that corresponds to the element D2 is text that describes what kind of painting the Mona Lisa is. The text D4 that corresponds to the element D2 may not necessarily exist in the document DB 300. The text D4 that corresponds to the element D2 may also be text accompanying the element D2.

In Embodiment 1, the obtaining unit 120 includes an information obtaining unit 121.

The information obtaining unit 121 obtains text D4 that corresponds to a target element from the document DB 300. The target element is each element D2 in the triple D1.

As a specific example, the information obtaining unit 121 obtains from the document DB 300, the text D4 that corresponds to the element D2 that has been inputted from the data receiving unit 110. At this time, in a case where text that corresponds to the element D2 does not exist in the document DB 300, a value that represents an absence of the text is stored in the text D4 instead of the text. The value that is stored may be a special character such as Null or the like. The value that is stored, however, is not an essential feature of the present disclosure.

The information obtaining unit 121 outputs the text D4 that is obtained to a feature extraction unit 131.

The training unit 130 has a function to create an embedded vector D6 that corresponds to the element D2 by combining the vector representation D3 that the data receiving unit 110 outputted and a text vector D5 that is the text D4 that the information obtaining unit 121 outputted vectorized.

In Embodiment 1, the training unit 130 includes the feature extraction unit 131 and an embedded learning unit 132.

The feature extraction unit 131 generates based on a target language model, a target text vector that corresponds to the text D4 that is obtained by the information obtaining unit 121. The target text vector is the text vector D5. The target language model is the language model 400.

As a specific example, the feature extraction unit 131 has a function to extract the text vector D5 by vectorizing, based on the language model 400, the text D4 that the information obtaining unit 121 outputted.

The language model 400 may be a model that utilizes a classical method such as Bag of Words, TF-IDF (Term Frequency-Inverse Document Frequency), or the like, and may be a model that uses a deep neural network such as BERT (Bidirectional Encoder Representations from Transformers).

As mentioned above, there is a case where a special value that represents that text does not exist is stored in the text D4 that the information obtaining unit 121 outputted. In a case where the special value is stored in the text D4, the feature extraction unit 131 does not perform a vectorization process by the language model 400, and stores the special value that represents an absence of a text vector in the text vector D5. The value that is stored may be a special character such as Null or the like. The value that is stored, however, is not an essential feature of the present disclosure.

The feature extraction unit 131 outputs the text vector D5 to the embedded learning unit 132.

The embedded learning unit 132 generates an embedded vector D6 that corresponds to the target element based on a target vector representation that corresponds to the target element and text information that corresponds to the target element, and learns a knowledge graph embedded representation that corresponds to the target knowledge graph based on the embedded vector D6 that is generated. Specifically, the embedded learning unit 132 generates the embedded vector D6 based on the target vector representation and a target text vector. The target vector representation is the vector representation D3. In a case where the text information that corresponds to the target element does not exist in the document DB 300, the embedded learning unit 132 regards the target vector representation as the embedded vector D6. The embedded learning unit 132 may generate the embedded vector D6 by matching the number of dimensions between the target vector representation and the target text vector, and merging the target vector representation and the target text vector after the number of dimensions have been matched.

As a specific example, the embedded learning unit 132 has a function to learn the embedded vector D6 that corresponds to the element D2 with the vector representation D3 that the data receiving unit 110 outputted and the text vector D5 that the feature extraction unit 131 outputted as input.

A process of the embedded learning unit 132 differs depending on whether or not the special value that represents the absence of the text vector is stored in the text vector D5.

A process will be described of the embedded learning unit 132 of a case where the text vector exists, that is, the value stored in the text vector D5 is a value other than the special value that represents the absence of the text vector.

First, the embedded learning unit 132 has the number of dimensions of the text vector D5 and the number of dimensions of the vector representation D3 match by executing a dimension adjustment process. As a specific example, in a case where the number of dimensions of the vector representation D3 is 200 and the number of dimensions of the text vector D5 is 768, the embedded learning unit 132 executes operation to increase the number of dimensions of the vector representation D3 up to 768 or operation to reduce the number of dimensions of the text vector D5 down to 200. In the dimension adjustment process, the embedded learning unit 132 may use a dimension adjustment method such as a principal component analysis or the like, and may use a neural network.

Then, the embedded learning unit 132 executes a merging process, that is, the embedded learning unit 132 creates the embedded vector D6 by merging the vector representation D3 and the text vector D5 after the number of dimensions has been adjusted. Here, the embedded vector D6 is a vector representation that corresponds to the element D2. During the merging process, the embedded learning unit 132 may calculate a sum of each element of the vector representation D3 and the text vector D5, and regard a vector that consists of each sum that is calculated as the embedded vector D6. The embedded learning unit 132 may input the vector representation D3 and the text vector D5 separately into two neural networks, and regard a vector that is outputted as the embedded vector D6.

In a case where the value that is stored in the text vector D5 is a special value that represents that the text vector does not exist, the embedded learning unit 132 does not execute the dimension adjustment process and the merging process that are mentioned above, and regards the vector representation D3 as the embedded vector D6 as is. That is, in a case where the text that corresponds to the element D2 does not exist in the document DB 300, the vector representation D3 that corresponds to the element D2 is regarded as the embedded vector D6 that corresponds to the element D2.

In a case where the embedded vector D6 that corresponds to each of all elements (h, r, and t) that are included in the triple D1 is obtained, the embedded learning unit 132 calculates a score using any known knowledge graph embedding learning algorithm using the embedded vector D6 that is obtained.

As a specific example, in a case where TransE is to be used as the knowledge graph embedding learning algorithm, the embedded learning unit 132 calculates the score using [Numerical Formula 1].

f(h, r, t)=−|h+r−t|₂ [Numerical Formula 1]

Each of h, r, and t on a right side of [Numerical Formula 1] is a vector representation that is obtained by the embedded learning unit 132.

In a case where a score for the triple D1 is obtained, the embedded learning unit 132 calculates an error, a gradient, and the like using any knowledge graph embedding learning algorithm. Each error, gradient, score, and vector representation that is calculated is stored in the storage unit 140.

Learning according to the present embodiment is a process to generate each of h1 that is the embedded vector D6 that corresponds to the head h, r1 that is the embedded vector D6 that corresponds to the relation r, and t1 that is the embedded vector D6 that corresponds to the tail t, and to adjust a representation of each of h1, r1, and t1 in a way that a score value that is calculated using h1, r1, and t1 that are generated approaches an optimal value.

The storage unit 140 has a function to store the embedded vector D6 that the embedded learning unit 132 learned, an embedded representation that is generated by the embedded learning unit 132, various parameters of the model, and the like.

The storage unit 140 is enabled by a storage device such as a ROM (Read Only Memory), a hard disk, or the like.

The storage unit 140 may be enabled on a single server or on a plurality of servers that are distributed across the cloud, and may also be implemented as a part of an edge storage device.

Each embedded vector D6 is stored in the storage unit 140 in a form that is associated with the element D2 that is received by the data receiving unit 110.

In a case where a vector representation relating to all triples that are included in the triple DB 200 is learned, a vector representation that corresponds to any element can be acquired via the storage unit 140. The vector representation that is acquired can be applied especially to major downstream tasks for knowledge graph completion such as link prediction, entity alignment, and the like.

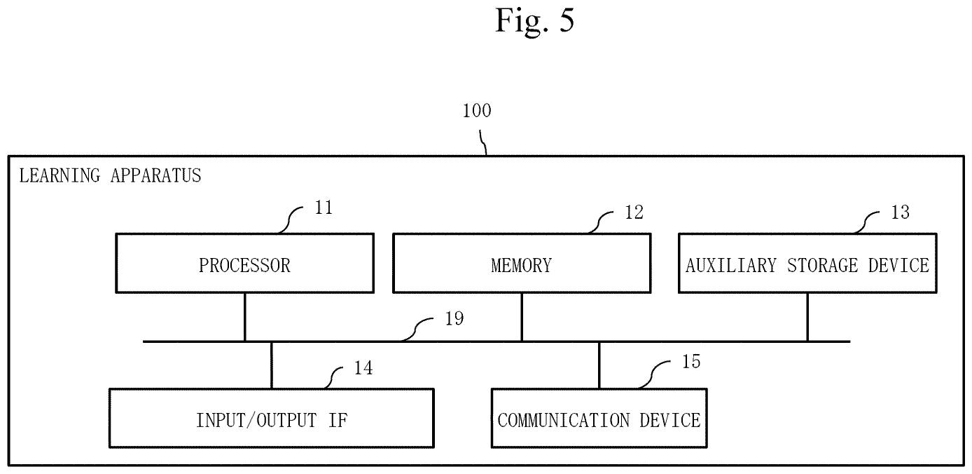

FIG. 5 illustrates an example of a hardware configuration of the learning apparatus 100 according to the present embodiment. The learning apparatus 100 consists of a computer. The learning apparatus 100 may also consist of a plurality of computers.

The learning apparatus 100, as illustrated in the present diagram, is a computer that includes hardware such as a processor 11, a memory 12, an auxiliary storage device 13, an input/output IF (Interface) 14, a communication device 15, and the like. These pieces of hardware are suitably connected through a signal line 19.

The processor 11 is an IC (Integrated Circuit) that performs a calculation process, and controls hardware that the computer includes. As a specific example, the processor 11 is a CPU (Central Processing Unit), a DSP (Digital Signal Processor), or a GPU (Graphics Processing Unit).

The learning apparatus 100 may include a plurality of processors that replace the processor 11. The plurality of processors share roles of the processor 11.

The memory 12 is typically a volatile storage device, and as a specific example, is a RAM (Random Access Memory). The memory 12 is also called a main storage device or a main memory. Data stored in the memory 12 is saved in the auxiliary storage device 13 as necessary.

The auxiliary storage device 13 is typically a non-volatile storage device, and as a specific example, is a ROM (Read Only Memory), an HDD (Hard Disk Drive), or a flash memory. Data stored in the auxiliary storage device 13 is loaded into the memory 12 as necessary.

The memory 12 and the auxiliary storage device 13 may be configured integrally.

The input/output IF 14 is a port to where an input device and an output device are connected. The input/output IF 14, as a specific example, is a USB (Universal Serial Bus) terminal. Input devices, as specific examples, are a keyboard and mouse. The output device, as a specific example, is a display.

The communication device 15 is a receiver and a transmitter. The communication device 15, as a specific example, is a communication chip or an NIC (Network Interface Card).

Each unit of the learning apparatus 100 may suitably use the input/output IF 14 and the communication device 15 when communicating with a different device and the like.

The auxiliary storage device 13 has stored a learning program. The learning program is a program that causes a computer to enable functions of each unit that the learning apparatus 100 includes. The learning program is loaded into the memory 12, and executed by the processor 11. The functions of each unit of the learning apparatus 100 includes are enabled by software.

Data used when executing the learning program, data obtained by executing the learning program, and the like are suitably stored in a storage device. Each part of the learning apparatus 100 suitably utilizes the storage device. The storage device, as a specific example, consists of at least one of the memory 12, the auxiliary storage device 13, a register in the processor 11, and a cache memory in the processor 11. There is a case where a term “data” and a term “information” have an equal meaning. The storage device may be a device that is independent of the computer.

Functions of the memory 12 and the auxiliary storage device 13 may be enabled by a different storage device.

The learning program may be recorded in a computer-readable non-volatile recording medium. The non-volatile recording medium, as a specific example, is an optical disc or a flash memory. The learning program may be provided as a program product.

### Description of Operation

An operation procedure of the learning apparatus is equivalent to a learning method. A program that enables operation of the learning apparatus is equivalent to the learning program.

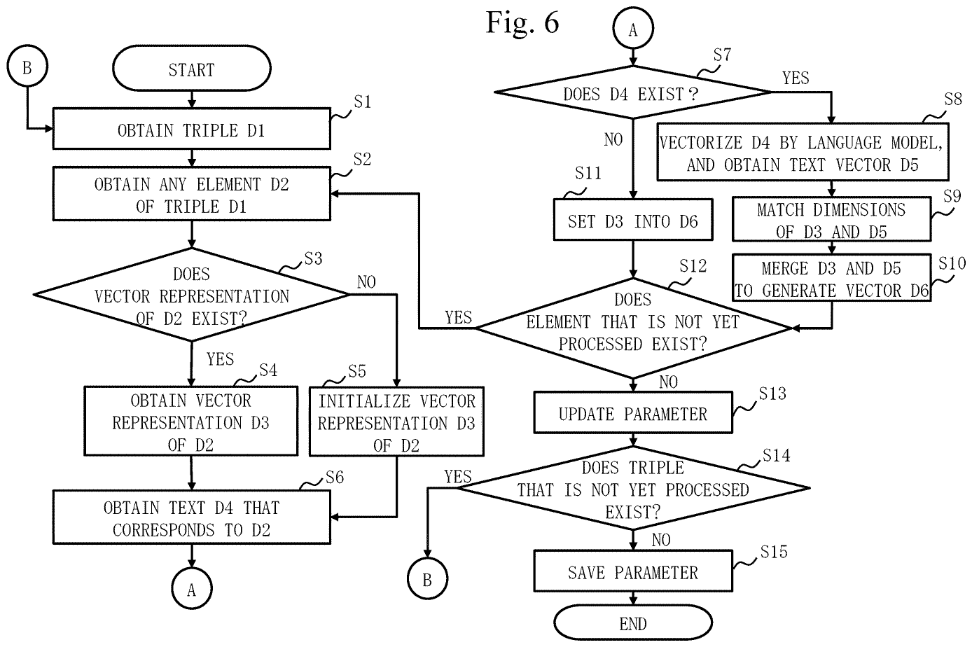

FIG. 6 is a flowchart illustrating an example of operation of the learning apparatus 100. The operation of the learning apparatus 100 will be described using FIG. 6.

### (Step S1)

The data receiving unit 110 obtains the triple D1 from the triple DB 200 as data for learning.

### (Step S2)

The data receiving unit 110 obtains, as the element D2, any element (h, r, or t) that is included in the triple D1 that is obtained.

### (Step S3)

The data receiving unit 110 determines whether or not the vector representation that corresponds to the element D2 exists. In a case where the data receiving unit 110 determined that the vector representation that corresponds to the element D2 exists, the operation proceeds to step S4, and in a case where the data receiving unit 110 determined that the vector representation that corresponds to the element D2 does not exist, the operation proceeds to step S5.

### (Step S4)

The data receiving unit 110 reads and obtains the vector representation D3 that corresponds to the element D2 from a storage medium (not illustrated).

### (Step S5)

The data receiving unit 110 generates the vector representation D3 that corresponds to the element D2 using any vector initialization method.

### (Step S6)

The information obtaining unit 121 obtains the text D4 that corresponds to the element D2 from the document DB 300. In a case where the text that corresponds to the element D2 does not exist in the document DB 300, the information obtaining unit 121 stores in the text D4, the special value that represents that the text that corresponds does not exist.

### (Step S7)

The information obtaining unit 121 determines whether or not the text that corresponds to the element D2 is stored in the text D4. In a case where the information obtaining unit 121 determined that the text that corresponds to the element D2 is stored in the text D4, the operation proceeds to step S8, and in a case where the information obtaining unit 121 determined that the text that corresponds to the element D2 is not stored in the text D4, the operation proceeds to step S11.

### (Step S8)

The feature extraction unit 131 obtains the text vector D5 by vectorizing, by the language model 400, the text that is stored in the text D4.

### (Step S9)

The embedded learning unit 132 matches the number of dimensions of the vector representation D3 and the number of dimensions of the text vector D5 by adjusting either the number of dimensions of the vector representation D3 that corresponds to the element D2 or the number of dimensions of a text vector D5 that corresponds to the element D2.

### (Step S10)

The embedded learning unit 132 generates a final embedded vector D6 that corresponds to the element D2 by merging the vector representation D3 that corresponds to the element D2 and the text vector D5 that corresponds to the element D2.

### (Step S11)

The embedded learning unit 132 uses the vector representation D3 that corresponds to the element D2 as the final embedded vector D6 that corresponds to the element D2.

(step S12)

The embedded learning unit 132 determines whether or not an element that is not yet processed exists. In a case where the embedded learning unit 132 determined that an element that is not yet processed exists, the operation returns to step S2, and in a case where the embedded learning unit 132 determined that an element that is not yet processed does not exist, the operation proceeds to step S13.

### (Step S13)

The embedded learning unit 132 performs a parameter update of a knowledge graph embedding model by performing processes such as an error calculation, a gradient calculation, and the like using vector representations that are obtained relating to each of the elements (h, r, and t) of the triple D1.

### (Step S14)

The embedded learning unit 132 determines whether or not a triple that is not yet processed exists. In a case where the embedded learning unit 132 determined that a triple that is not yet processed exists, the operation returns to step S1, and in a case where the embedded learning unit 132 determined that a triple that is not yet processed does not exist, the operation proceeds to step S15.

### (Step S15)

The storage unit 140 stores the model and the parameter that are updated.

### Description of Effect of Embodiment 1

Through the operation as described above, the learning apparatus 100 according to Embodiment 1, when generating a vector representation for any element that is included in the triple, learns the embedded representation by combining structural information of an entity relationship and its corresponding text information. Consequently, according to the present embodiment, expressiveness of knowledge graph embedding can be improved, and performance of major tasks for knowledge graph completion such as link prediction, entity alignment, and the like can be improved.

The learning apparatus 100 according to Embodiment 1, when generating a vector representation for any element included in the triple, learns using only a structural vector representation of each element in a case where text that describes each element does not exist. Consequently, according to the present embodiment, even in a knowledge graph where auxiliary information of text does not correspond to every element, accuracy of link prediction, entity alignment, and the like can be improved.

### Other Configurations

### <Variation 1>

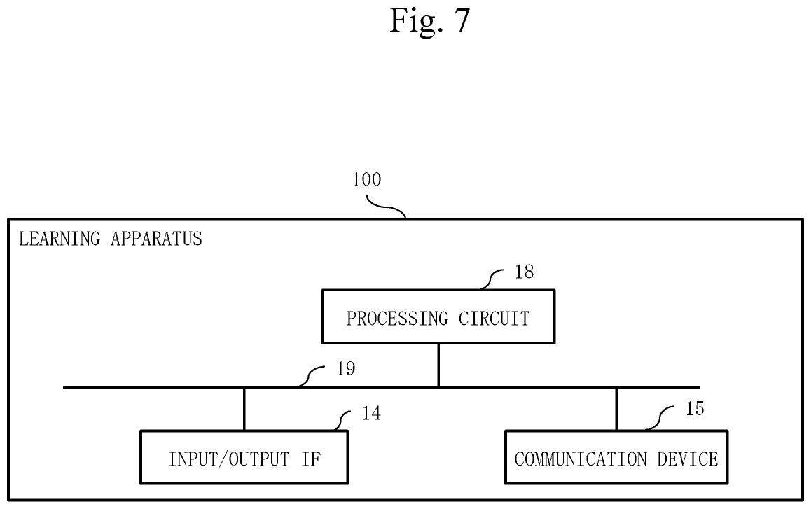

FIG. 7 illustrates an example of a hardware configuration of a learning apparatus 100 according to the present variation.

The learning apparatus 100 includes a processing circuit 18 instead of the processor 11, the processor 11 and the memory 12, the processor 11 and the auxiliary storage device 13, or the processor 11, the memory 12, and the auxiliary storage device 13.

The processing circuit 18 is hardware that enables at least some of each unit that the learning apparatus 100 includes.

The processing circuit 18 may be dedicated hardware or a processor that executes a program that is stored in the memory 12.

In a case where the processing circuit 18 is dedicated hardware, the processing circuit 18, as a specific example, is a single circuit, a composite circuit, a programmed processor, a parallel programmed processor, an ASIC (Application Specific Integrated Circuit), an FPGA (Field Programmable Gate Array), or a combination of these.

The learning apparatus 100 may include a plurality of processing circuits that replace the processing circuit 18. The plurality of processing circuits share roles of the processing circuit 18.

In the learning apparatus 100, some of functions may be enabled by dedicated hardware and the rest of the functions may be enabled by software or firmware.

The processing circuit 18, as a specific example, is enabled by hardware, software, firmware, or a combination of these.

The processor 11, the memory 12, the auxiliary storage device 13, and the processing circuit 18 are generically called “processing circuitry”. That is, functions of each functional element of the learning apparatus 100 are enabled by the processing circuitry.

As for the learning apparatus according to other embodiments, the configuration may be in a same configuration as the configuration in the present variation.

### Embodiment 2

Points different from the embodiment mentioned above will mainly be described below while referring to the drawings.

In Embodiment 2, a configuration in which the document DB 300 is removed from the configuration of Embodiment 1, and in addition to the configuration of Embodiment 1, a string generation unit 152 that carries out a normalization process for a string that is directly assigned to any element included in the triple is added will be described.

In a case where a total amount of text that corresponds to a certain element is noticeably small, there is a case where learning fully utilizing information of the text cannot be executed. A learning apparatus 101 according to Embodiment 2 obtains a label that is directly assigned to any element in the triple, carries out a normalization process for the label that is obtained, and executes a process that vectorizes, by a language model, the label of which the normalization process has been carried out. By the present process, even in a case where the total amount of the text that corresponds to the certain element is noticeably small, by utilizing label information that represents an entity relationship that is included in the label, the expressiveness of the knowledge graph embedding can be improved, and link prediction accuracy can be improved.

### Description of Configuration

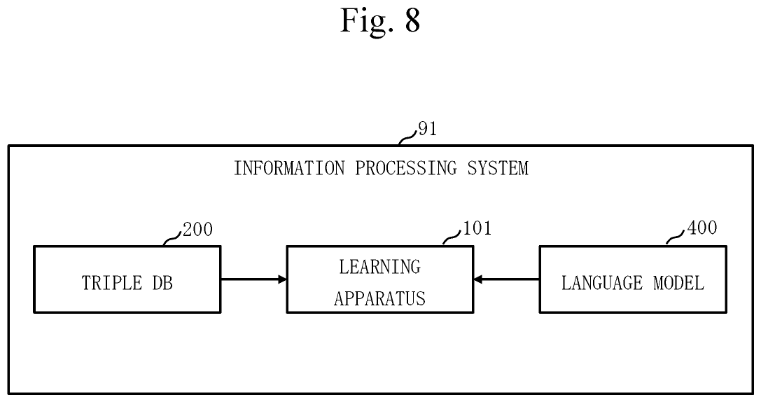

FIG. 8 illustrates an example of a configuration of an information processing system 91 according to Embodiment 2.

The configuration of the information processing system 91, except for not having the document DB 300 according to Embodiment 1, is a same as the configuration of the information processing system 90 according to Embodiment 1.

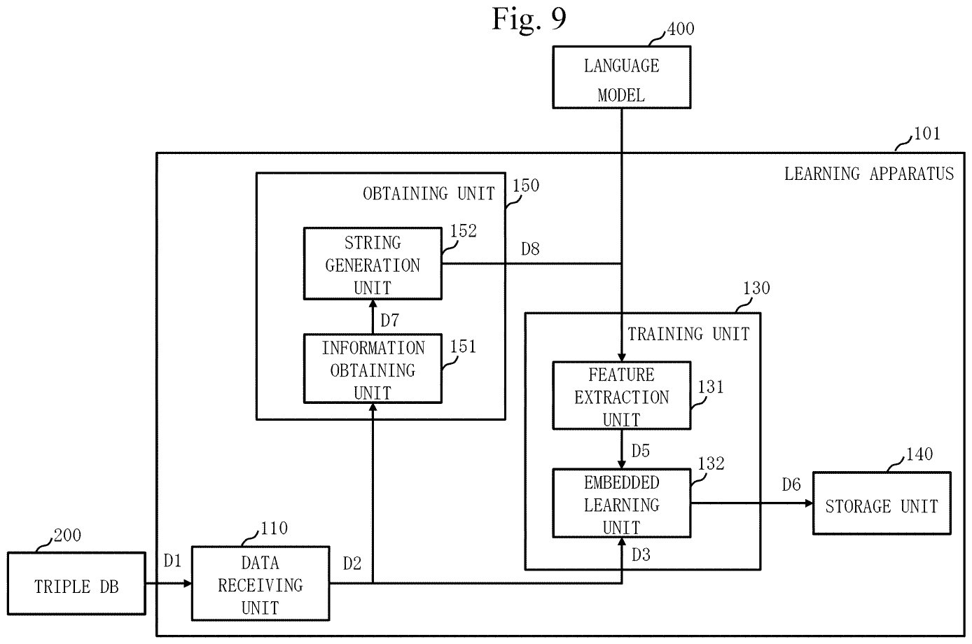

FIG. 9 illustrates an example of a configuration of the learning apparatus 101 according to Embodiment 2.

The learning apparatus 101 includes the data receiving unit 110, an obtaining unit 150, the training unit 130, and the storage unit 140.

As for each of the data receiving unit 110, the training unit 130, and the storage unit 140, each is a same as the data receiving unit 110, the training unit 130, and the storage unit 140 of Embodiment 1.

The obtaining unit 150 has a function to obtain a label string D7 that is directly assigned to the element D2, inputted from the data receiving unit 110, to generate a normalized label string D8 by carrying out a string normalization process to the label string D7 that is obtained, and to output the normalized label string D8 that is generated.

In Embodiment 2, the obtaining unit 150 includes an information obtaining unit 151 and the string generation unit 152.

The information obtaining unit 151 obtains the label string D7 that is directly assigned to the element D2, inputted from the data receiving unit 110.

A string that represents the element D2 is stored in the element D2 that is inputted from the data receiving unit 110. That is, in a case where the triple that is inputted in the data receiving unit 110 is <Tokyo, is_capital_of, Japan>, and of these, an element, “Tokyo”, is selected, the string that is stored in the element D2 is “Tokyo”. Therefore, a substantial function of the information obtaining unit 151 is merely a function to substitute a value of the element D2 into the label string D7.

The string generation unit 152 generates the normalized label string D8 by carrying out the normalization process on a target label string. The normalized label string D8 is the text information that corresponds to the target element. The target label string is the label string D7.

As a specific example, the string generation unit 152 generates the normalized label string D8 by carrying out the string normalization process on the label string D7 that is inputted from the information obtaining unit 151, and outputs the normalized label string D8 that is generated to the feature extraction unit 131.

The string generation unit 152, as the string normalization process, executes removal of an underscore symbol that is included in the label string D7, removal of frequently appearing words such as “is” and “of”, and the like. As a specific example, when the string stored in the label string D7 is “is_capital_of”, a string that is to be stored in the normalized label string D8 becomes “is capital of” by executing the removal of the underscore symbol, and becomes “capital” by the removal of the frequently appearing words. The present example is merely an example of the normalization process. A specific method of the string normalization process, however, is not an essential feature of the present disclosure.

The string generation unit 152 does not have to perform the string normalization process. That is, a value of the label string D7, as is, may be regarded as the normalized label string D8.

The feature extraction unit 131 according to the present embodiment generates based on the target language model, a target text vector that corresponds to the normalized label string D8 that was generated by the string generation unit 152.

### Description of Operation

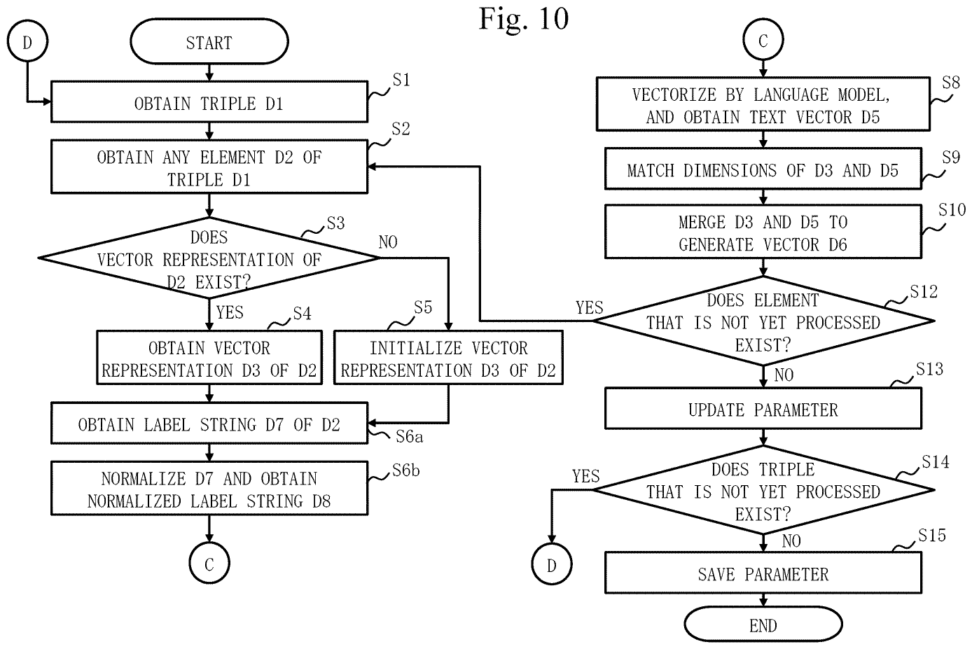

FIG. 10 is a flowchart illustrating an example of operation of the learning apparatus 101. The operation of the learning apparatus 101 will be described using FIG. 10.

In a process illustrated in FIG. 10, step S6, step S7, and step S11 are not executed. In the process illustrated in FIG. 10, unlike the process illustrated in FIG. 6, step S6a and step S6b are executed. Consequently, with regard to FIG. 10, step S6a and step S6b will be described. As for other steps illustrated in FIG. 10, explanations of processes will be omitted by adding same step numbers as the step numbers illustrated in FIG. 6.

### (Step S6a)

The information obtaining unit 151 obtains the label string that is directly assigned to the element D2, inputted from the data receiving unit 110, and stores the label string that is obtained in the label string D7.

### (Step S6b)

The string generation unit 152 generates a normalized label string by carrying out the string normalization process on the label string D7 that is inputted from the information obtaining unit 151, and stores the normalized label string that is generated in the normalized label string D8.

### Description of Effect of Embodiment 2

The learning apparatus 101 according to Embodiment 2 substitutes the label of the element as the text that corresponds to the element. Consequently, according to the present embodiment, even for a knowledge graph that has no element linked to the document DB 300 or a knowledge graph to which extremely few elements are linked to the document DB 300, accuracy of downstream tasks such as link prediction, entity alignment, and the like can be improved.

### Embodiment 3

Points different from the embodiments mentioned above will mainly be described below while referring to the drawings.

In Embodiment 3, a configuration of which a string generation unit 162, a search unit 163, and an explanatory model 500 are added to the configuration of Embodiment 1 will be described.

In a case where a total amount of text that corresponds to a certain element is noticeably small, there is a case where learning fully utilizing the information of the text cannot be executed. Furthermore, the label of each element is often “Tokyo” or “capital” as the specific example mentioned above. Here, information that is obtained from such labels is limited.

A learning apparatus 102 according to Embodiment 3 obtains a label that is directly assigned to any element that is included in a triple, and executes a process to search for text that is related to the label that is obtained, or a process to acquire text that describes the label that is obtained through the explanatory model 500. By these processes, even for a knowledge graph of which the total amount of text that corresponds to a certain element is noticeably small, and in a case where the information that can be obtained from the label of the certain element is limited, the expressiveness of the knowledge graph embedding can be improved, and the accuracy of the downstream tasks such as link prediction, entity alignment, and the like can be improved.

### Description of Configuration

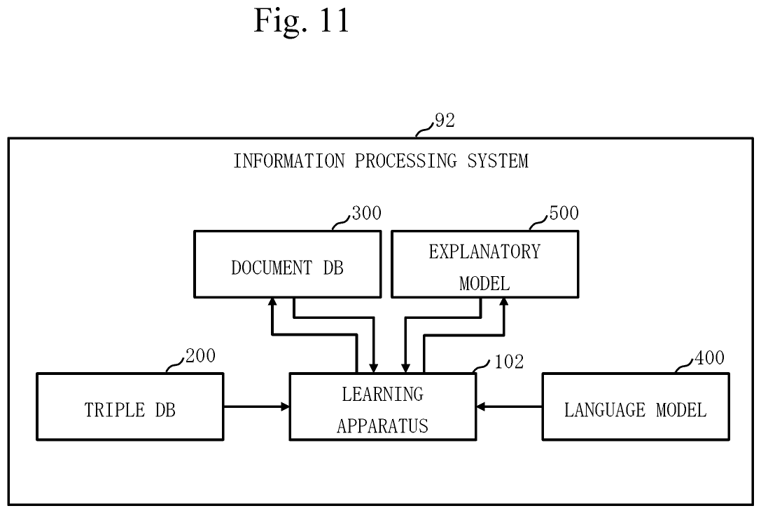

FIG. 11 illustrates an example of a configuration of an information processing system 92 according to Embodiment 3.

In addition to the elements that the information processing system 90 according to Embodiment 1 includes, the information processing system 92 includes the explanatory model 500.

When inputted data is received, the explanatory model 500 outputs based on the inputted data that is received, output data that corresponds to the inputted data. The explanatory model 500 is a model that outputs an explanation that corresponds to text that is inputted. The explanatory model 500 may be a generative AI (Artificial Intelligence).

The explanatory model 500, as a specific example, is a model that has been machine-learned through one of supervised learning, reinforcement learning, and unsupervised learning. The explanatory model 500, as a specific example, is a model that has been obtained by executing learning according to deep learning, a genetic program, a functional logic program, or a different known algorithm or method. The explanatory model 500, as a specific example, may be a model called an NN (Neural Network) model, a CNN (Convolutional Neural Network) model, an RNN (Recurrent Neural Network), a VAE (Variational Autoencoder), GAN (Generative Adversarial Networks), a Diffusion model, a Transformer model, an LLM (Large Language Model), a VLM (Visual Language Model), BERT, a GPT (Generative Pre-trained Transformer), or CLIP (Contrastive Language-Image Pre-training). The explanatory model 500 may also be a rule-based model that obtains an output result by referring to a predetermined table, or by performing determination based on a predetermined condition.

The models mentioned above are not necessarily exclusive of each other. As a specific example, each of the LLM, the VLM, the BERT, and the GPT is included in the Transformer model. As a specific example, the Transformer model is included in the NN model. Each learning algorithm and each of the models may be a combination of various types. A model that is called a multimodal model that is learned by combining different types of data is also included in the models.

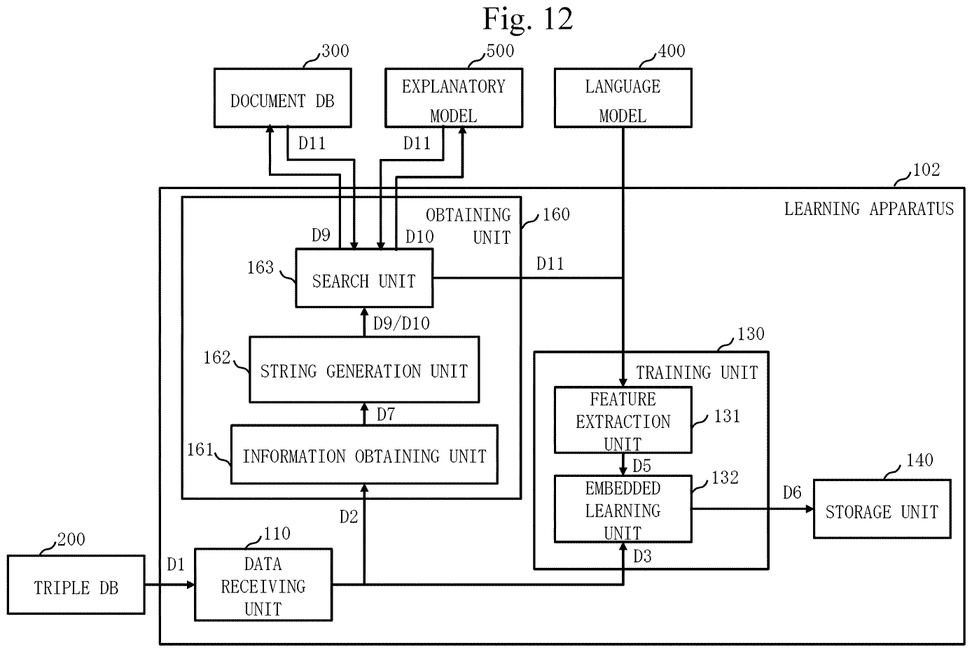

FIG. 12 illustrates an example of a configuration of the learning apparatus 102 according to Embodiment 3.

The learning apparatus 102 includes the data receiving unit 110, an obtaining unit 160, the training unit 130, and the storage unit 140.

The data receiving unit 110, the training unit 130, and the storage unit 140 are each the same as the data receiving unit 110, the training unit 130, and the storage unit 140 in Embodiment 1.

The obtaining unit 160 has a function to obtain the label string D7 that is directly assigned to the element D2 that is inputted from the data receiving unit 110, create a query D9 to search for text that is related to the label string D7 that is obtained, or create a prompt D10 that causes text that describes the label string that is obtained to be outputted, and search for or generate the text by the query D9 or by the prompt D10 that is created, and output text D11 that is obtained.

In Embodiment 3, the obtaining unit 160 includes an information obtaining unit 161, the string generation unit 162, and the search unit 163.

As for the information obtaining unit 161, the information obtaining unit 161 is a same as the information obtaining unit 161 of Embodiment 2.

The string generation unit 162 generates the query D9 that is used to search for text D11 that corresponds to a target label string included in the target element in the document DB 300. The string generation unit 162 generates the prompt D10 that is used to cause the explanatory model 500 to generate the text D11 that corresponds to the target label string included in the target element. The query D9 is used to search for the text D11 that is related to the label string D7 that is inputted. The prompt D10 is used to cause the explanatory model 500 to generate the text D11 that describes the label string D7 that is inputted.

As a specific example, the string generation unit 162 generates the query D9 or the prompt D10 when the label string D7 is inputted from the information obtaining unit 161.

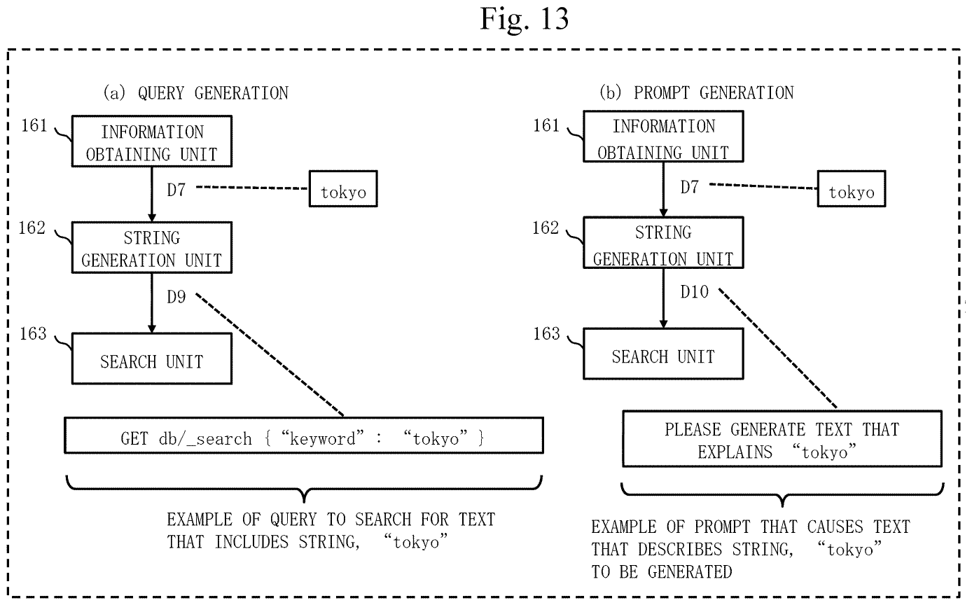

A specific example of a process of the string generation unit 162 will be described using FIG. 13.

FIG. 13 is a conceptual diagram illustrating a specific example of the process of the string generation unit 162.

Firstly, a specific example of a process of a case where the string generation unit 162 generates the query D9 will be described, and then, a specific example of a process of a case where the string generation unit 162 generates the prompt D10 will be described.

In a case where the query D9 is to be generated, the label string D7 that corresponds to the element D2 is inputted to the string generation unit 162 from the information obtaining unit 161. The string generation unit 162 generates the query D9 that searches for text that includes the label string D7 that is inputted. The query D9 that is generated is queried to the document DB 300 via the search unit 163.

The query D9 illustrated in (a) of FIG. 13 is an example of the query D9 of a case where text that includes a string, “tokyo”, is to be searched through a GET request to an HTTP server when the document DB 300 is implemented by the HTTP (Hypertext Transfer Protocol) server. A format of the query D9 that the string generation unit 162 generates is a format in accordance with a form of the document DB 300.

In a case where the prompt D10 is to be generated, the label string D7 that corresponds to the element D2 is inputted into the string generation unit 162 from the information obtaining unit 161. The string generation unit 162 generates the prompt D10 that causes text that describes the label string D7 to be generated. The prompt D10 that is generated is queried to the explanatory model 500 via the search unit 163.

The prompt D10 illustrated in (b) of FIG. 13 is an example of the prompt D10 of a case where a prompt that causes a generative language model to generate text that describes a string such as “tokyo” when the explanatory model 500 is a generative language model that is configured by the GPT or the like is inputted. A format and terminology of the prompt D10 that the string generation unit 162 generates is a format and terminology in accordance with a form of the explanatory model 500.

The search unit 163 obtains the text information that corresponds to the target element by searching the document DB 300 based on the query D9 that is generated by the string generation unit 162. The search unit 163 obtains the text information that corresponds to the target element by inputting the prompt D10 that is generated by the string generation unit 162 into the explanatory model 500.

As a specific example, the search unit 163 inputs the query D9 or the prompt D10 that were inputted by the string generation unit 162 into the document DB 300 or the explanatory model 500, and outputs to the feature extraction unit 131, a response that is obtained as text D11 that corresponds to the element D2.

Firstly, a specific example of a process of a case where the search unit 163 inputs the query D9 into the document DB 300 will be described. Then, a specific example of a case where the search unit 163 inputs the prompt D10 into the explanatory model 500 will be described.

The search unit 163 inputs the query D9 that is generated by the string generation unit 162 into the document DB 300. As a specific example, the document DB 300 outputs one of instances of text that includes the label string D7, based on the query D9.

The text that is outputted is stored in the text D11. Afterwards, the text D11 is inputted into the feature extraction unit 131.

The search unit 163 inputs the prompt D10 that the string generation unit 162 generated into the explanatory model 500. As a specific example, the explanatory model 500 outputs, based on the prompt D10, the text that describes the label string D7.

The text that is outputted is stored in the text D11. Afterwards, the text D11 is inputted into the feature extraction unit 131.

The feature extraction unit 131 according to the present embodiment generates, based on the target language model, a target text vector that corresponds to the text D11 that is obtained by the search unit 163.

### Description of Operation

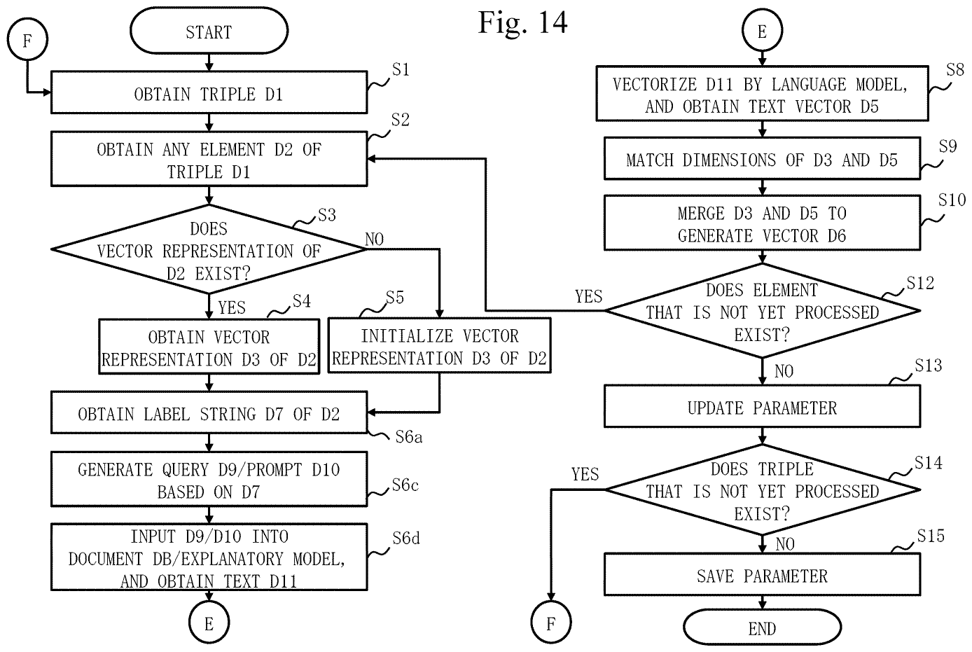

FIG. 14 is a flowchart illustrating an example of operation of the learning apparatus 102. The operation of the learning apparatus 102 will be described using FIG. 14.

In a process illustrated in FIG. 14, unlike the process illustrated in FIG. 10, step S6c and step S6d are executed. Consequently, with regard to FIG. 14, step S6c and step S6d will be described. As for other steps illustrated in FIG. 14, explanations of processes will be omitted by adding same step numbers as the step numbers illustrated in FIG. 10.

### (Step S6c)

The string generation unit 162 generates the query D9 to search for the text that is related to the label string D7, or the prompt D10 that causes the text that describes the label string D7 to be generated.

### (Step S6d)

The search unit 163 inputs the query D9 that is inputted from the string generation unit 162 into the document DB 300, or inputs the prompt D10 that is inputted from the string generation unit 162 into the explanatory model 500.

Afterwards, the search unit 163 stores in the text D11, the text that is obtained.

### Description of Effect of Embodiment 3

The learning apparatus 102 according to Embodiment 3 obtains the text that describes the element from an external resource as the text that corresponds to the element by searching, in the document DB 300, for the text that is related to the label string of the element. Consequently, according to the present embodiment, the accuracy of the downstream tasks such as link prediction, entity alignment, and the like can be improved.

The learning apparatus 102 according to Embodiment 3 causes the explanatory model 500 to generate the text that describes the label string of the element as the text that corresponds to the element. Consequently, according to the present embodiment, the text that describes the element can be flexibly utilized even in the knowledge graph that has no element linked to the document DB 300, or in the knowledge graph to which extremely few elements are linked to the document DB 300. According to the present embodiment, the accuracy of the downstream tasks such as link prediction, entity alignment, and the like can be improved.

### Other Embodiments

A free combination of each embodiment mentioned above, or a variation of any element of each embodiment, or omitting of any element in each embodiment is possible.

The embodiments are not to be limited to the embodiments indicated in Embodiments 1 to 3, and various changes are possible to be made as necessary. Procedures described using the flowcharts and the like may suitably be changed.

### REFERENCE SIGNS LIST

11: processor; 12: memory; 13: auxiliary storage device; 14: input/output IF; 15: communication device; 18: processing circuit; 19: signal line; 90, 91, 92: information processing system; 100, 101, 102: learning apparatus; 110: data receiving unit; 120: obtaining unit; 121: information obtaining unit; 130: training unit; 131: feature extraction unit; 132: embedded learning unit; 140: storage unit; 150: obtaining unit; 151: information obtaining unit; 152: string generation unit; 160: obtaining unit; 161: information obtaining unit; 162: string generation unit; 163: search unit; 200: triple DB; 300: document DB; 400: language model; 500: explanatory model; D1: triple; D2: element; D3: vector representation; D4: text; D5: text vector; D6: embedded vector; D7, D8: label string; D9: query; D10: prompt; D11: text.

1. A learning apparatus comprising:
processing circuitry to:
when each element of a triple that consists of two entities and one relation that are included in a target knowledge graph, a knowledge graph, is regarded as a target element, generate an embedded vector that corresponds to the target element based on a target vector representation that corresponds to the target element and on text information that corresponds to the target element, and learn a knowledge graph embedded representation that corresponds to the target knowledge graph based on the embedded vector that is generated;
generate a query that is used to search for text that corresponds to a target label string included in the target element in a document database that consists of document data;
obtain the text information that corresponds to the target element by searching the document database based on the query that is generated; and
generate based on a target language model that is a language model, a target text vector that corresponds to text that is obtained, wherein
the processing circuitry generates the embedded vector based on the target vector representation and the target text vector.

2. A learning apparatus comprising:
processing circuitry to:
when each element of a triple that consists of two entities and one relation that are included in a target knowledge graph, a knowledge graph, is regarded as a target element, generate an embedded vector that corresponds to the target element based on a target vector representation that corresponds to the target element and on text information that corresponds to the target element, and learn a knowledge graph embedded representation that corresponds to the target knowledge graph based on the embedded vector that is generated;
generate a prompt that is used to cause an explanatory model that outputs an explanation that corresponds to text that is inputted to generate text that corresponds to a target label string included in the target element;
obtain the text information that corresponds to the target element by inputting the prompt that is generated into the explanatory model; and
generate based on a target language model that is a language model, a target text vector that corresponds to text that is obtained, wherein the processing circuitry generates the embedded vector based on the target vector representation and the target text vector.

3. The learning apparatus according to claim 1, wherein
the processing circuitry obtains the text information that corresponds to the target element from a document database that consists of document data,
generates a target text vector that corresponds to text that is obtained based on a target language model that is a language model, and
generates the embedded vector based on the target vector representation and the target text vector.

4. The learning apparatus according to claim 2, wherein
the processing circuitry
obtains the text information that corresponds to the target element from a document database that consists of document data,
generates a target text vector that corresponds to text that is obtained based on a target language model that is a language model, and
generates the embedded vector based on the target vector representation and the target text vector.

5. The learning apparatus according to claim 3, wherein
the processing circuitry, in a case where the text information that corresponds to the target element does not exist in the document database, regards the target vector representation as the embedded vector.

6. The learning apparatus according to claim 4, wherein
the processing circuitry, in a case where the text information that corresponds to the target element does not exist in the document database, regards the target vector representation as the embedded vector.

7. The learning apparatus according to claim 1, wherein
the processing circuitry
generates a normalized label string as the text information that corresponds to the target element by carrying out a normalization process on a target label string that is included in the target element,
generates based on a target language model that is a language model, a target text vector that corresponds to the normalized label string that is generated, and
generates the embedded vector based on the target vector representation and the target text vector.

8. The learning apparatus according to claim 2, wherein
the processing circuitry
generates a normalized label string as the text information that corresponds to the target element by carrying out a normalization process on a target label string that is included in the target element,
generates based on a target language model that is a language model, a target text vector that corresponds to the normalized label string that is generated, and
generates the embedded vector based on the target vector representation and the target text vector.

9. The learning apparatus according to claim 5, wherein
the processing circuitry, in a case where the text information that corresponds to the target element exists in the document database, generates the embedded vector by matching the number of dimensions between the target vector representation and the target text vector, and merging the target vector representation and the target text vector after the number of dimensions have been matched.

10. The learning apparatus according to claim 6, wherein
the processing circuitry, in a case where the text information that corresponds to the target element exists in the document database, generates the embedded vector by matching the number of dimensions between the target vector representation and the target text vector, and merging the target vector representation and the target text vector after the number of dimensions have been matched.

11. A learning method comprising:
when each element of a triple that consists of two entities and one relation that are included in a target knowledge graph, a knowledge graph, is regarded as a target element, generating an embedded vector that corresponds to the target element based on a target vector representation that corresponds to the target element and on text information that corresponds to the target element, and learning a knowledge graph embedded representation that corresponds to the target knowledge graph based on the embedded vector that is generated;
generating a query that is used to search for text that corresponds to a target label string included in the target element in a document database that consists of document data;
obtaining the text information that corresponds to the target element by searching the document database based on the query that is generated;
generating based on a target language model that is a language model, a target text vector that corresponds to text that is obtained; and
generating the embedded vector based on the target vector representation and the target text vector.

12. A learning method comprising:
when each element of a triple that consists of two entities and one relation that are included in a target knowledge graph, a knowledge graph, is regarded as a target element, generating an embedded vector that corresponds to the target element based on a target vector representation that corresponds to the target element and on text information that corresponds to the target element, and learning a knowledge graph embedded representation that corresponds to the target knowledge graph based on the embedded vector that is generated;
generating a prompt that is used to cause an explanatory model that outputs an explanation that corresponds to text that is inputted to generate text that corresponds to a target label string included in the target element;
obtaining the text information that corresponds to the target element by inputting the prompt that is generated into the explanatory model;
generating based on a target language model that is a language model, a target text vector that corresponds to text that is obtained; and
generating the embedded vector based on the target vector representation and the target text vector.

13. A non-transitory computer readable medium storing a learning program that causes a learning apparatus that is a computer to execute:
an embedded learning process, when each element of a triple that consists of two entities and one relation that are included in a target knowledge graph, a knowledge graph, is regarded as a target element, to generate an embedded vector that corresponds to the target element based on a target vector representation that corresponds to the target element and on text information that corresponds to the target element, and to learn a knowledge graph embedded representation that corresponds to the target knowledge graph based on the embedded vector that is generated;
a string generation process to generate a query that is used to search for text that corresponds to a target label string included in the target element in a document database that consists of document data;
a search process to obtain the text information that corresponds to the target element by searching the document database based on the query that is generated; and
a feature extraction process to generate based on a target language model that is a language model, a target text vector that corresponds to text that is obtained, wherein
in the embedded learning process, the embedded vector is generated based on the target vector representation and the target text vector.

14. A non-transitory computer readable medium storing a learning program that causes a learning apparatus that is a computer to execute:
an embedded learning process, when each element of a triple that consists of two entities and one relation that are included in a target knowledge graph, a knowledge graph, is regarded as a target element, to generate an embedded vector that corresponds to the target element based on a target vector representation that corresponds to the target element and on text information that corresponds to the target element, and to learn a knowledge graph embedded representation that corresponds to the target knowledge graph based on the embedded vector that is generated;
a string generation process to generate a prompt that is used to cause an explanatory model that outputs an explanation that corresponds to text that is inputted to generate text that corresponds to a target label string included in the target element;
a search process to obtain the text information that corresponds to the target element by inputting the prompt that is generated into the explanatory model; and
a feature extraction process to generate based on a target language model that is a language model, a target text vector that corresponds to text that is obtained, wherein
in the embedded learning process, the embedded vector is generated based on the target vector representation and the target text vector.
